(19) United States
(12) Patent Application Publication
(10) Pub. No.: US 2025/0380086 A1
(43) Pub. Date: Dec. 11, 2025

(54) ACOUSTIC SYSTEM FOR CHAIR AND CHAIR WITH BUILT-IN SPEAKERS

(71) Applicant: ALPS ALPINE CO., LTD., Tokyo (JP)

(72) Inventor: Tomohiko ISE, Fukushima (JP)

(21) Appl. No.: 19/226,724

(22) Filed: Jun. 3, 2025

(30) Foreign Application Priority Data
Jun. 5, 2024 (JP) 2024-091530

(51) Int. Cl. H04R 5/02; H04R 5/04; H04S 7/00

(52) U.S. Cl. CPC H04R 5/023; H04R 5/04; H04S 7/308; H04S 2400/13

(57) ABSTRACT

An acoustic system for a chair, the acoustic system includes the chair, a support member configured to be arranged on a side of a head of a user when in use, an inward-facing speaker supported by the support member, configured to emit sound toward an inside of the chair in a left-right direction of the chair, an outward-facing speaker supported by the support member, configured to emit sound toward an outside of the chair in the left-right direction of the chair, and a sound field control processor configured to process a signal of a listening target sound, which is intended to be heard by the user when in use, to enable local reproduction of the listening target sound within a predetermined zone surrounding the chair, and to output the processed signal to the inward-facing speaker and the outward-facing speaker.

### CROSS-REFERENCE TO RELATED APPLICATION

The present application is based on and claims priority to Japanese patent application No. 2024-91530 filed on June 5, 2024, with the Japan Patent Office, the entire contents of which are hereby incorporated by reference.

### BACKGROUND OF THE INVENTION

### 1. Field of the Invention

The disclosures herein relate to technologies for reducing leakage of sound output from a speaker in a chair with built-in speakers, to the surroundings.

### 2. Description of the Related Art

In a chair with built-in speakers, a technology is known for reducing the leakage of sound output from the speakers to the surroundings (e.g., Patent Literature (PTL) 1). An acoustic device, designed to surround the left, right, and rear of a user’s head when seated in the chair, includes a speaker emitting sound inward from the left of the head, a speaker emitting sound inward from the right of the head, and a sound insulation member. This sound insulation member reduces sound leakage to the outside.

As a technology related to the present disclosure, a boundary sound field control technology is known (e.g., PTLs 2, 3). This technology minimizes magnitude of a listening target sound propagating outside a zone where the user is located by outputting the listening target sound from a plurality of speakers at a boundary of the zone. It does so in such a way that an interference sound field of each speaker’s sound creates a sound field where the sound pressure and the sound pressure gradient of the listening target sound become zero. This process is based on a Kirchhoff-Helmholtz integral equation.

According to the technology using the acoustic device designed to surround the left, right, and rear of the user’s head when seated in the chair described above, sound leakage in a forward direction is not reduced because sound insulation is not performed in the front of the user.

In addition, sound leakage due to diffraction cannot be reduced in the left, right, and rear directions. Even in the absence of sound leakage due to diffraction, if the speaker volume is high, the sound insulation member alone cannot sufficiently reduce sound leakage.

Therefore, it is conceivable to reduce sound leakage outside a certain zone including the chair by applying the above-described boundary sound field control technology to this acoustic device.

However, when a plurality of speakers emitting sound from the left and right of the user’s head toward the inside of the chair are arranged in the acoustic device designed to surround the left, right, and rear of the user’s head, the speaker sound, which is mainly responsible for canceling the leakage sound, reaches only as a sound with low sound pressure due to diffracted waves at a position to the left, right, and rear of the chair, and therefore, the sound field cannot be controlled so that the sound pressure and the sound pressure gradient are approximately zero at the boundary of the zone, and the leakage to the outside of the zone cannot be sufficiently reduced.

In addition, since a length of the acoustic device in the front-rear direction must be limited so that a visual field in the front direction of the user is not damaged as much as possible, a distance between the speakers on the left and right sides of the acoustic device cannot be large, and as a result, a sufficient phase difference between the speaker sounds at the boundary of the zone cannot be secured in a low range and the like, and as a result, the sound field cannot be controlled so that the sound pressure and the sound pressure gradient are approximately zero at the boundary of the zone, and the leakage to the outside of the zone may not be sufficiently reduced.

Accordingly, in the chair with built-in speakers, the leakage of sound output from the speakers to the surroundings is more appropriately reduced.

### CITATION LIST

### PATENT LITERATURES

[PTL 1] Japanese Laid-Open Patent Publication No. 2023-103862

[PTL 2] Japanese Laid-Open Patent Publication No. 2006-74442

[PTL 3] Japanese Laid-Open Patent Publication No. 2008-252625

### SUMMARY OF THE INVENTION

An acoustic system for a chair, the acoustic system includes the chair, a support member configured to be arranged on a side of a head of a user when in use, an inward-facing speaker supported by the support member, configured to emit sound toward an inside of the chair in a left-right direction of the chair, an outward-facing speaker supported by the support member, configured to emit sound toward an outside of the chair in the left-right direction of the chair, and a sound field control processor configured to process a signal of a listening target sound, which is intended to be heard by the user when in use, to enable local reproduction of the listening target sound within a predetermined zone surrounding the chair, and to output the processed signal to the inward-facing speaker and the outward-facing speaker.

An acoustic system for a chair, the acoustic system includes the chair, a left support member configured to be arranged to left of a head of a user when in use, a right support member arranged to right of the head of the user seated in the chair, one or more left inward-facing speakers supported by the left support member, configured to emit sound toward an inside of the chair in a left-right direction of the chair, one or more left outward-facing speakers supported by the left support member, configured to emit sound toward an outside of the chair in the left-right direction of the chair, one or more right inward-facing speakers supported by the right support member, configured to emit sound toward the inside of the chair in the left-right direction of the chair, one or more right outward-facing speakers supported by the right support member, configured to emit sound toward the outside of the chair in the left-right direction of the chair, and a sound field control processor configured to process a signal of a listening target sound, which is intended to be heard by the user when in use, to enable local reproduction of the listening target sound within a predetermined zone surrounding the chair, and to output a processed signal to the one or more left inward-facing speakers, the left one or more outward-facing speakers, the one or more right inward-facing speakers, and the one or more right outward-facing speakers.

According to the acoustic system for the chair and a chair with built-in speakers described above, four speakers emitting sound from the sides of the head toward the inside of the chair and a speaker emitting sound from the side toward the outside of the chair are provided as speakers for performing local reproduction, so that the speaker sound, which is responsible for canceling leakage sound, can be delivered as sound from the speaker emitting sound toward the outside even at a position on the side or the rear side of the chair, and as a result, leakage of the listening target sound from the surrounding zone of the chair can be more appropriately reduced.

As described above, according to the present disclosure, in a chair with built-in speakers, leakage of sound output from the speaker to the surroundings can be more appropriately reduced.

### BRIEF DESCRIPTION OF THE DRAWINGS

FIG. 1 is a block diagram illustrating a configuration of a chair acoustic system according to an embodiment of the present disclosure;

FIG. 2A is a right side view illustrating an arrangement of speakers according to the embodiment of the present disclosure;

FIG. 2B is a front view illustrating the arrangement of speakers according to the embodiment of the present disclosure;

FIG. 2C is a left side view illustrating the arrangement of speakers according to the embodiment of the present disclosure;

FIG. 2D is a rear view illustrating the arrangement of speakers according to the embodiment of the present disclosure;

FIG. 2E is a top view illustrating the arrangement of speakers according to the embodiment of the present disclosure;

FIG. 2F is an enlarged view of a part of FIG. 2E;

FIG. 3A is a side view illustrating an example of a boundary where sound pressure and sound pressure gradient are controlled by the chair acoustic system;

FIG. 3B is a top view illustrating the example of the boundary where sound pressure and sound pressure gradient are controlled by the chair acoustic system;

FIG. 4 is a drawing illustrating a configuration of the chair acoustic system according to the embodiment of the present disclosure when setting a filter coefficient;

FIG. 5A is a side view illustrating an arrangement of acoustic sensors of the chair acoustic system according to the embodiment of the present disclosure when setting the filter coefficient; and

FIG. 5B is a top view illustrating the arrangement of acoustic sensors of the chair acoustic system according to the embodiment of the present disclosure when setting the filter coefficient.

### DESCRIPTION OF THE PREFERRED EMBODIMENTS

In the following, embodiments of the present disclosure will be described.

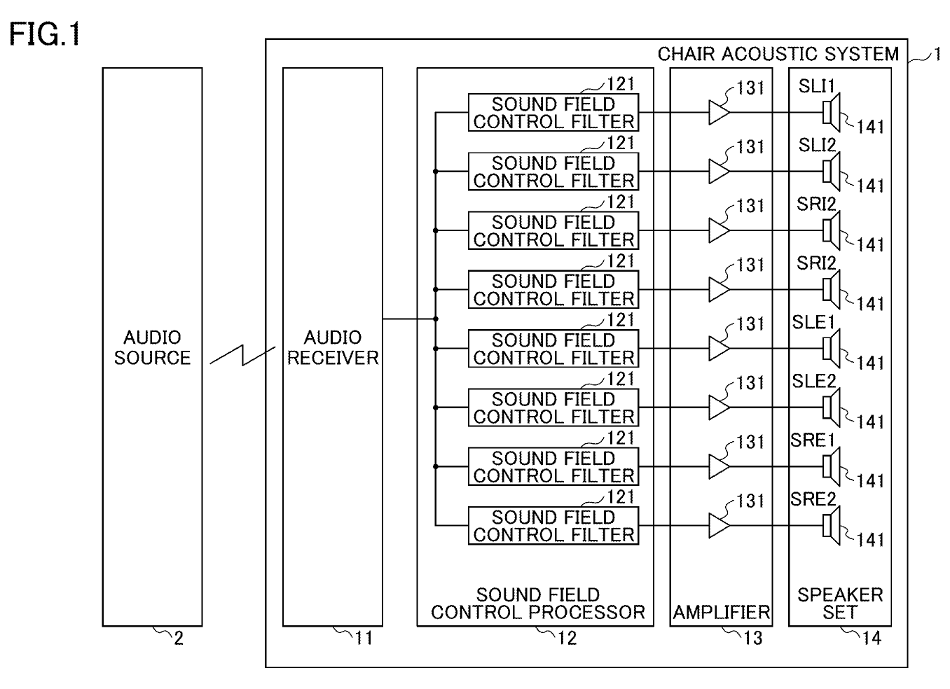

FIG. 1 is a block diagram illustrating a configuration of a chair acoustic system according to an embodiment of the present disclosure.

The chair acoustic system is a system built into a chair with built-in speakers, and controls a sound field so that a user seated in the chair with built-in speakers can hear a predetermined listening target sound well and others outside the zone around the chair with built-in speakers cannot hear it.

As shown FIG. 1, the chair acoustic system 1 includes an audio receiver 11, a sound field control processor 12, an amplifier 13, and a speaker set 14.

The speaker set 14 includes eight speakers 141: SLI1, SLI2, SRI1, SRI2, SLE1, SLE2, SRE1, and SRE2.

The amplifier 13 includes eight amplifiers 131 corresponding one-to-one to the speakers 141, and the sound field control processor 12 includes eight sound field control filters 121 corresponding one-to-one to the speakers 141.

The audio receiver 11 receives a reproduction sound of audio content from the audio source 2 for reproducing the audio content as a listening target sound via wireless communication, and outputs the received sound to each sound field control filter 121.

Each sound field control filter 121 is, for example, an FIR filter, and a filter coefficient (transfer characteristic) for performing a predetermined sound field control is set in each sound field control filter 121 in advance. Each sound field control filter 121 convolves the target audio, which is input from the audio receiver 11, with a transfer characteristic defined by preset filter coefficients. This sound is output to the corresponding speaker 141 via the same amplifier 131. Each amplifier 131 then amplifies the post-filter listening target sound received from the sound field control filter 121 and sends it to the corresponding speaker 141.

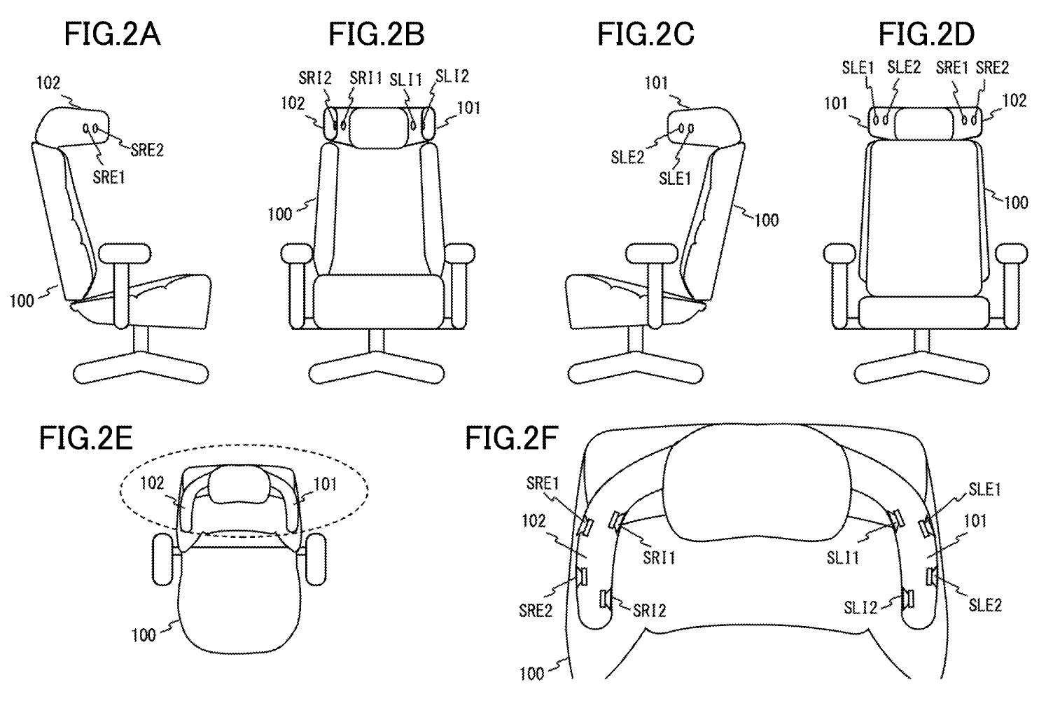

FIGS. 2A to 2F show an arrangement of eight speakers 141 of SLI1, SLI2, SRI1, SRI2, SLE1, SLE2, SRE1, and SRE2.

FIG. 2A is a right side view, FIG. 2B is a top view, FIG. 2C is a left side view, FIG. 2D is a rear view, and FIG. 2E is a top view of the chair 100 with built-in speakers, and FIG. 2F is an enlarged view of a part of FIG. 2E.

As shown in FIGS. 2A to 2E, the chair 100 with built-in speakers includes, as members for supporting each speaker 141, a left off-ear panel 101 extending forward from the left of a headrest to a position on the left of the head of the user on the chair 100 with built-in speakers, and a right off-ear panel 102 extending forward from the right of the headrest to a position on the right of the head of the user on the chair 100 with built-in speakers.

Of the eight speakers 141, SLI1 and SLI2 are arranged on the right (inside the chair) of the left off-ear panel 101 in a front-rear direction so as to emit sound toward the right (inside the chair), SRI1 and SRI2 are arranged on the left (inside the chair) of the right off-ear panel 102 in a front-rear direction so as to emit sound toward the left (inside the chair), SRE1 and SRE2 are arranged on the left (outside the chair) of the left off-ear panel 101 in a front-rear direction so as to emit sound toward the left (outside the chair), and SRE1 and SRE2 are arranged on the right (outside the chair) of the right off-ear panel 102 in a front-rear direction so as to emit sound toward the right (outside the chair).

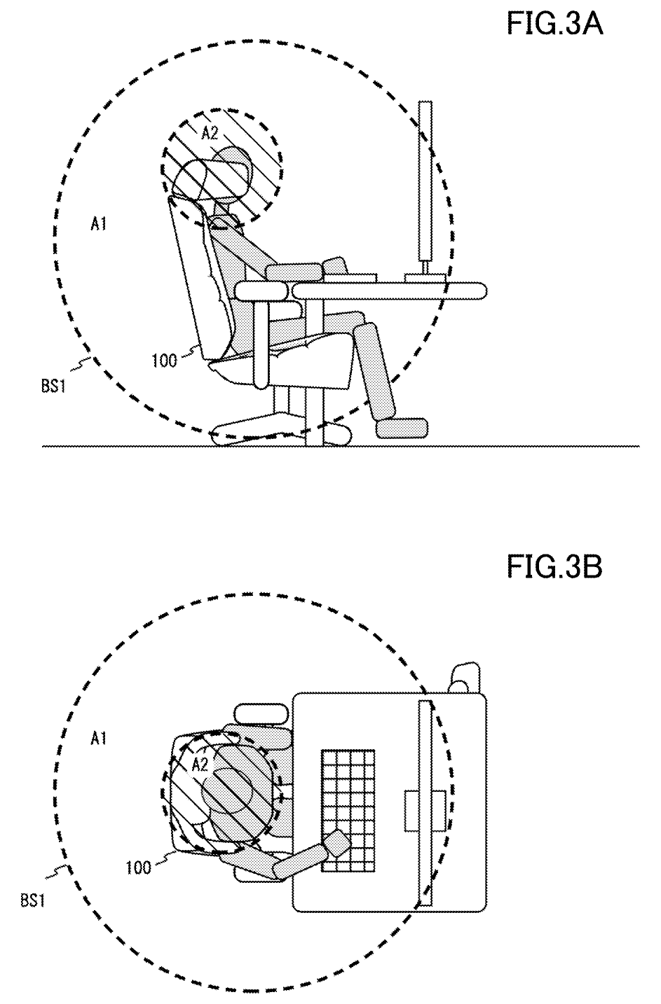

Next, FIGS. 3A and 3B are drawings illustrating an example of sound field control of the listening target sound achieved by each sound field control filter 121.

As shown in FIG. 3A as a side view and FIG. 3B as a top view, the sound field control achieved by each sound field control filter 121 is performed so that the boundary sound field control is achieved such that the sound pressure and the sound pressure gradient of the listening target sound are minimized, that is, reduced to a level as close to zero as practically achievable, at a boundary BS1, which is the boundary of the surrounding zone A1 of the user on the chair 100 with built-in speakers. By performing such boundary sound field control, the listening target sound leaked outside the boundary BS1 is minimized, and the listening target sound is locally reproduced in the surrounding zone A1. Minimizing the sound pressure gradient is equivalent to minimizing a particle speed.

The sound field control achieved by each sound field control filter 121 is performed so that the listening target sound reaches an audible zone A2 around the head of the user seated in the chair 100 with built-in speakers with a natural sound pressure suitable for listening to the listening target sound.

The audible zone A2 is a zone inside the surrounding zone A1. The surrounding zone A1 is, for example, a zone within 1 m to 1.5 m from the user on the chair 100 with built-in speakers.

With such sound field control, the user on the chair 100 with built-in speakers can hear the listening target sound well, and the listening target sound leaking out of the surrounding zone A1 of the user on the chair with built-in speakers can be minimized.

Here, in the present embodiment, as the speakers 141 for performing the sound field control as described above, in addition to the four speakers 141: SLI1, SLI2, SRI1, and SRI2 which emit sound from the left and right sides of the head toward the inside of the chair 100 with built-in speakers, four speakers 141: SLE1, SLE2, SRE1, and SRE2 which emit sound toward the outside of the chair 100 with built-in speakers are provided respectively on the left and right.

Therefore, the speaker sound for canceling the leakage sound can be delivered as sound from the four speakers 141 of SLE1, SLE2, SRE1, and SRE2 which emit sound toward the outside of the chair at the left, right, and rear of the chair, and as a result, leakage of the listening target sound from the surrounding zone A1 of the chair 100 with built-in speakers can be more appropriately reduced.

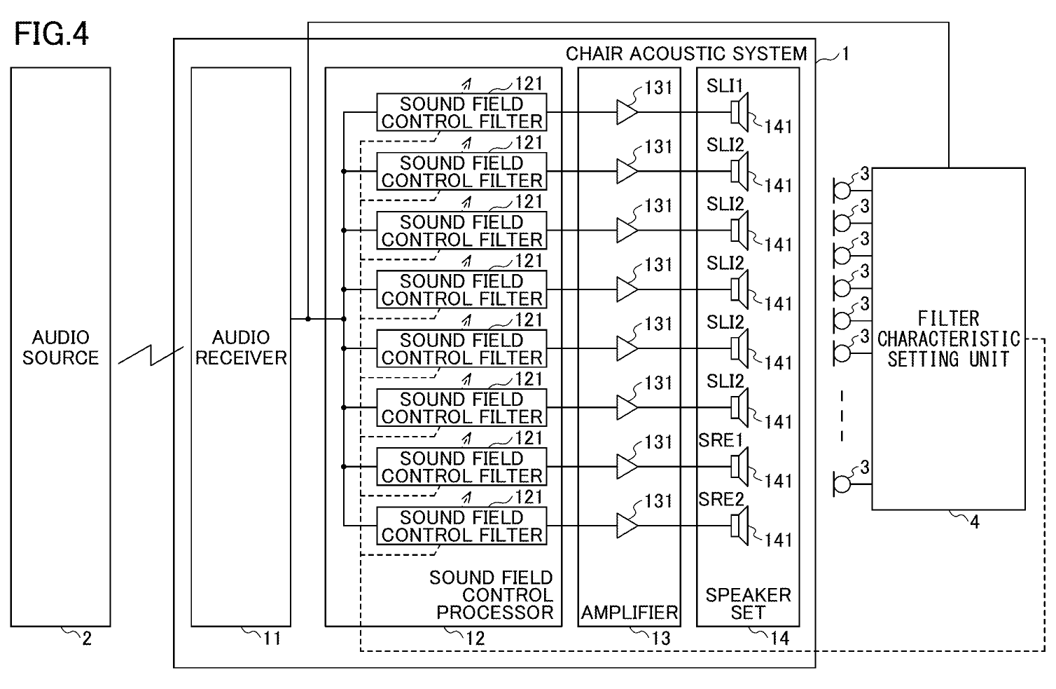

Here, each sound field control filter 121 can be set in advance in the configuration shown in FIG. 4.

As shown in FIG. 4, this configuration is made by adding a plurality of sound sensors 3 such as a microphone, a microphone array, a sound pressure sensor, and a sound pressure gradient sensor, and a filter characteristic setting unit 4 to the configuration of the chair acoustic system 1 shown in FIG. 1.

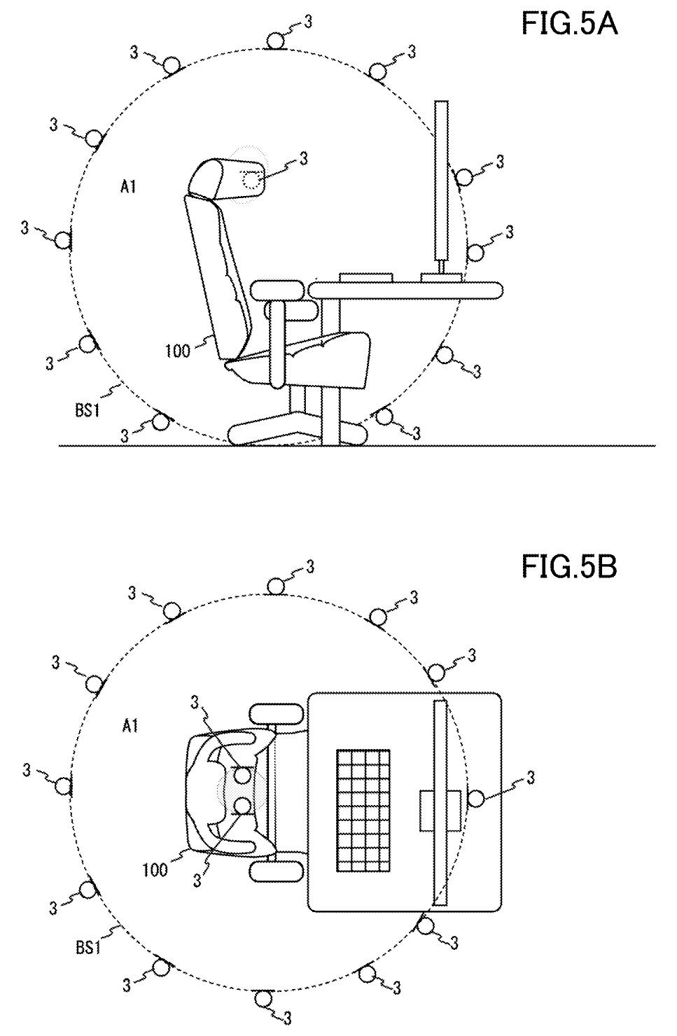

As shown in FIG. 5A as a side view and FIG. 5B as a top view, the sound sensors 3 are respectively arranged at a plurality of positions (control points) on the boundary BS1 of the surrounding zone A1 and at standard positions (control points) of the left and right ears of the user on the chair 100 with built-in speakers.

Then, a transfer function from each speaker 141 to each control point is found based on the listening target sound and the output of each sound sensor 3, and from the found transfer function, a filter coefficient of the sound field control filter 121 which a filter coefficient of the field control filter 121 is calculated so as to realize a target response at each control point as closely as possible is calculated and set to each sound field control filter 121. Here, the target response at the control point is a response in which the sound pressure and the sound pressure gradient are zero for the control points which are a plurality of positions on the boundary BS1. The target response at the control point is basically a response in which a magnitude of the sound follows the listening target sound at the control point which is a standard position of the left and right ears of the user seated. Here, the response in which the magnitude of the sound follows the listening target sound includes a sound in which an acoustic characteristic which improves the listening experience of the user is given to the listening target sound.

The foregoing describes the embodiment of the present disclosure.

Portions of the chair acoustic system 1 in the above embodiment except for the speaker set 14 may be provided outside the chair 100 with built-in speakers.

In the above description, 2 speakers 141 are disposed in each of the inner and outer parts of the left off-ear panel 101 and the inner and outer parts of the right off-ear panel 102, but the number of speakers 141 disposed in each part may be selectable, and the number may be different in each part.

What is claimed is:

1. An acoustic system for a chair, the acoustic system comprising:
the chair;
a support member configured to be arranged on a side of a head of a user when in use;
an inward-facing speaker supported by the support member, configured to emit sound toward an inside of the chair in a left-right direction of the
chair;
an outward-facing speaker supported by the support member, configured to emit sound toward an outside of the chair in the left-right direction of the chair; and
a sound field control processor configured to process a signal of a listening target sound, which is intended to be heard by the user when in use, to enable local reproduction of the listening target sound within a predetermined zone surrounding the chair, and to output the processed signal to the inward-facing speaker and the outward-facing speaker.

2. An acoustic system for a chair, the acoustic system comprising:
the chair;
a left support member configured to be arranged to left of a head of a user when in use;
a right support member arranged to right of the head of the user seated in the chair;
one or more left inward-facing speakers supported by the left support member, configured to emit sound toward an inside of the chair in a left- right direction of the chair;
one or more left outward-facing speakers supported by the left support member, configured to emit sound toward an outside of the chair in the left- right direction of the chair;
one or more right inward-facing speakers supported by the right support member, configured to emit sound toward the inside of the chair in the left- right direction of the chair;
one or more right outward-facing speakers supported by the right support member, configured to emit sound toward the outside of the chair in the left-right direction of the chair; and
a sound field control processor configured to process a signal of a listening target sound, which is intended to be heard by the user when in use, to enable local reproduction of the listening target sound within a predetermined zone surrounding the chair, and to output a processed signal to the one or more left inward-facing speakers, the left one or more outward-facing speakers, the one or more right inward-facing speakers, and the one or more right outward-facing speakers.

3. The acoustic system for the chair according to claim 2, wherein:
the sound field control processor is configured to convolve the signal of the listening target sound with a respective transfer function corresponding to each speaker, among the one or more left inward-facing speakers, the one or more left outward-facing speakers, the one or more right inward-facing speakers, and the one or more right outward-facing speakers, and to supply an output signal obtained by convolving the signal of the listening target sound with the respective transfer function to a corresponding speaker; and
the respective transfer function corresponding to each speaker is set such that a sound pressure and a sound pressure gradient of the listening target sound are minimized at a boundary of the zone.

4. The acoustic system for the chair according to claim 3, wherein the respective transfer function corresponding to each speaker is set for the listening target sound to be satisfactorily audible in a region surrounding the head of the user when in use.

5. A chair with built-in speakers, comprising:
the chair; and
the acoustic system for the chair of claim 1,
wherein the sound field control processor is built in the chair.
